(19) United States
(12) Patent Application Publication
(10) Pub. No.: US 2020/0267409 A1
(43) Pub. Date: Aug. 20, 2020

(54) EARLY TERMINATION OF BLOCK-MATCHING FOR COLLABORATIVE FILTERING

(71) Applicant: Huawei Technologies Co., Ltd., Shenzhen (CN)

(72) Inventors: Victor Alexeevich STEPIN, Shenzhen (CN); Roman Igorevich CHERNYAK, Shenzhen (CN); Ruslan Faritovich MULLAKHMETOV, Shenzhen (CN)

(21) Appl. No.: 16/807,994

(22) Filed: Mar. 3, 2020

Related U.S. Application Data
(63) Continuation of application No. PCT/RU2017/000646, filed on Sep. 5, 2017.

(51) Int. Cl. H04N 19/557; H04N 19/117; H04N 19/137; H04N 19/176; H04N 19/82

(52) U.S. Cl. CPC H04N 19/557; H04N 19/117; H04N 19/82; H04N 19/176; H04N 19/137

(57) ABSTRACT

The present disclosure relates to the iterative fast-search of more than one identified best blocks, corresponding to best patches within a search area, by early termination of the subblock iteration through comparison of a similarity measure to a similarity threshold. In particular, the positions of K-best matched-blocks, divided into multiple subblocks, are found for a reference block within an image search area. By performing subblock-based iterative calculations of the similarity measure between a block at a current position and the reference block within a search area, the iteration progresses as long as the similarity measure value remains larger than a threshold value, and the positions of the K-best patches are recorded in a storage medium, whereas the subblock iteration terminates when the similarity measure value is lower than the threshold value.

### CROSS-REFERENCE TO RELATED APPLICATIONS

This application is a continuation of International Application No. PCT/RU2017/000646, filed on Sep. 5, 2017, the disclosure of which is hereby incorporated by reference in its entirety.

### TECHNICAL FIELD

The present disclosure relates to filtering of an image block using a plurality of similar blocks and in particular to a block-matching technique to find the similar blocks.

### BACKGROUND

Image filtering is frequently used to emphasize certain features of an image or to enhance the objective or perceptual quality of the filtered image. One of the powerful tools for image filtering is collaborative filtering. Collaborative filtering has been used for instance as a de-noising filter for still images, as is described in detail by Kostadin Dabov et al. “Image denoising by sparse 3D transform-domain collaborative filtering”, IEEE Trans. on image processing, vol. 16, no. 8, Aug. 2007, which is herein incorporated by reference in its entirety. Moreover, an application about collaborative filtering to video coding and decoding has been provided by International Application No. PCT/RU2016/000920, filed on Dec. 23, 2016, which is herein incorporated by reference in its entirety.

In general, collaborative filtering enhances the quality of an image by identifying groups of similar blocks within the image and using them for filtering. Accordingly, an important part of the filtering is the provision for such groups of similar blocks, which is performed typically by block matching. The principle of the block-matching technique, according to prior art, is illustrated in FIG. 1 for a reference block R with a size of N×N image samples (N being an integer larger than one) and up to a predefined maximum block size. Such predefined maximum block size may be specified by the standard or pre-configured. For instance, the predefined maximum block size may be 8×8 or 16×16 (or some other size). The reference block is referred to as base macro-block in the exemplary FIG. 1. In order to find a block, which matches best the reference block, a search region is defined around the reference block R. In this example, the search region of size M×M is defined, with M being larger than N. The location of the search region here is concentric around the reference block. The search region specifies a set of candidate positions in the image in which the best-matching blocks to the reference block is looked for. Typically, the search region includes M×M samples of the image and each of the sample position of the M×M candidate positions is tested. The test includes calculation of a similarity measure between the N×N reference block R and a block C, located at the tested candidate position of the search region. The block C may also be referred to as candidate block. For its simplicity, the sum of absolute differences (SAD) is a measure frequently used for this purpose and given by:

SAD(x,y)=Σᵢ₌₀^{N-1}Σⱼ₌₀^{N-1}|C_{i,j}(x,y)−R_{i,j}| (Eq. 1)

In the above formula, x and y define the candidate position within the search region. The candidate position is often referred to as block displacement or offset, which reflects the representation of the block matching as shifting of the reference block within the search region and calculating a similarity between the reference block R and the overlapped portion of the search region. In FIG. 1, the offset block C is illustrated at the candidate position located in the top portion of the search region. Here, the reference for the position is the center of the reference block R: the search space is construed around the center of the reference block R and thus also candidate blocks C are construed as N×N block with its center being located at the candidate position within the search region. Indices i and j denote samples within the reference block R and candidate block C. After calculating SAD for all M×M candidate positions x and y, the best matching block C is the block on the position resulting in the lowest SAD, corresponding to the largest similarity with reference block R. Thus, in order to test all candidate positions, i.e., for a full search when all possible M×M offsets inside the search region (also referred to sometimes as a search window or a search space) are tested and all pixels inside the N×N reference block are used for the SAD calculation, the number of required operations is proportional N*N*M*M, with “*” denoting multiplication. This complexity of the block matching algorithm is a severe limitation factor of the collaborative filtering usage.

Collaborative filters do not use only one, but in general K best-matching blocks, with K being larger than one. Accordingly, there is a need to provide an efficient search for K best-matching blocks. The larger the search region, the better best-matching blocks may be found. However, the complexity may be limiting factor especially for real-time applications and specifically for video encoding and decoding applications which may employ collaborative filtering.

### SUMMARY

In view of the above mentioned problems, the present disclosure provides filtering of a reference block, based on an efficient search for K best-matching blocks for the reference block.

In particular, the filtering of the reference block includes subdividing the reference block into a plurality of subblocks and calculating a similarity measure iteratively on a subblock basis, i.e., subblock by subblock. If the similarity after a number of subblocks is smaller than a given threshold (low similarity), the calculation of the similarity is skipped and a further offset is tested. If on the other hand, the similarity is larger than the threshold after the calculation of the similarity for all subblocks of the reference block, the tested position is included among the K best positions (e.g., K best matching blocks).

According to an aspect of the disclosure, an apparatus is provided for filtering a reference block based on K best-matching blocks within a search area of an image, K being an integer larger than one. The apparatus comprises a processing circuitry which is configured to: divide the reference block into multiple non-overlapping subblocks; perform calculation of a similarity measure between the reference block and a block at a current position within the search area iteratively on a subblock basis, wherein said calculation is aborted, if the similarity measure in a current iteration indicates similarity lower than a predetermined threshold value; include the current position among the positions of K best-matching blocks if the similarity measure calculated for all subblocks of the reference block indicates a similarity higher than the predetermined threshold value; and filter the reference block using the K best-matching blocks located in the respective positions.

One of the advantages of such filtering is good performance given by the use of K patches and, at the same time, decreased computational complexity achieved by the iterative, subblock-based search for the K patches. This makes said filtering, e.g., also applicable for video coding and decoding.

According to an example, the processing circuitry is configured to update the threshold by setting said threshold to a value corresponding to a function of the similarity measure value calculated between the reference block and the worst-matching block among the K best-matching blocks.

For instance, the processing circuitry is configured to include the current position among the positions of K best-matching blocks stored in a storage by: adding the current position among the stored positions of K best-matching blocks if there are currently less than K positions of best-matching blocks stored, and replacing the position of the worst-matching block among the positions of K best-matching blocks otherwise. The processing circuitry is further advantageously configured to update the threshold upon replacing the position of the worst-matching block among the positions of K best-matching blocks.

The processing circuitry may be configured to perform said calculation in a loop (cycle) for each position within the search area corresponding to the reference block.

The processing circuitry may be further configured to set the predetermined threshold value before starting the loop (cycle) to an initial value based on quantization noise of the image.

For example, the processing circuitry is configured to pre-select the positions belonging to the search area based on properties of the image inside search area.

According to an embodiment, the reference block and the search area are located within the same image and the processing circuitry is configured to determine the location of the search area within said image depending on the location of the reference block within the image.

For example, the similarity metric is sum of absolute differences or sum of square differences.

Each of the multiple subblocks includes at least one image sample. A subblock may have a form of any of a sample row, sample column, square area of adjacent samples, and rectangular area of samples.

The apparatus may further comprise a storage or means for accessing a storage, the storage storing, for the reference block, the positions of K best-matching blocks within the search area in association with the values of the similarity measure calculated between the respective K best-matching blocks and the reference block.

The filter is advantageously configured to perform collaborative filtering of the reference block using the K best-matching blocks as patches.

According to an aspect of the disclosure, an apparatus (e.g., an encoder) for encoding an image is provided, the apparatus comprising: an image coding circuitry configured to perform image compression and generating a bitstream including the coded image; an image reconstruction circuitry configured to perform image reconstruction of the compressed image; the apparatus for image filtering of the reconstructed image as described above.

The encoder advantageously further comprises an optimization circuitry which in operation performs a rate-complexity-distortion process based on a predefined cost function based on a rate, distortion and number of operations required, resulting in selection of: (i) the predetermined threshold; and/or (ii) size and/or form of the subblocks for the reference block.

According to another aspect of the disclosure, an apparatus (e.g., decoder) for decoding an image from a bitstream is provided, the apparatus comprising: a bitstream parser for extracting from the bitstream portions corresponding to a compressed image to be decoded; an image reconstruction circuitry configured to perform image reconstruction of the compressed image; the apparatus for image filtering of the reconstructed image as described above.

In the decoder, the image may be a video image and the apparatus for image filtering is a post filter; i.e., a filter filtering a video frame reconstructed from the bitstream before outputting (e.g., displaying) the decoded video frame.

Alternatively, or in addition, the apparatus for image filtering may be employed as an in-loop filter for prediction improvement in the encoder and/or the decoder.

Advantageously, the bitstream includes one or more of: an indication of quantization noise, an indication of event that quantization noise is derived from quantization parameter QP, an indication of the predetermined threshold, and an indication of a size and/or a form of the subblocks.

In accordance with another aspect of the disclosure, a method is provided for filtering a reference block based on K best-matching blocks within a search area of an image, K being an integer larger than one, the method comprising the steps of: dividing the reference block into multiple non-overlapping subblocks; performing calculation of a similarity measure between the reference block and a block at a current position within the search area iteratively on a subblock basis; terminating said calculation, if the similarity measure in a current iteration indicates similarity lower than a predetermined threshold value; including the current position among the positions of K best-matching blocks if the similarity measure calculated for all subblocks of the reference block indicates a similarity higher than the predetermined threshold value; and filtering the reference block using the K best-matching blocks located in the respective positions.

According to an example, the method further comprises the step of updating the threshold by setting said threshold to a value corresponding to a function of the similarity measure value calculated between the reference block and the worst-matching block among the K best-matching blocks.

For instance, the method further comprises the step of including the current position among the positions of K best-matching blocks stored in a storage by: adding the current position among the stored positions of K best-matching blocks if there are currently less than K positions of best-matching blocks stored, and replacing the position of the worst-matching block among the positions of K best-matching blocks otherwise. The method may further include updating the threshold upon replacing the position of the worst-matching block among the positions of K best-matching blocks.

The calculation step may be performed in a loop (cycle) for each position within the search area corresponding to the reference block.

The method advantageously includes setting the predetermined threshold value before starting the loop (cycle) to an initial value based on quantization noise of the image.

For example, the method may further comprise the step of pre-selecting the positions belonging to the search area based on properties of the image inside search area.

According to an embodiment, the reference block and the search area are located within the same image and the method may further include determining of the location of the search area within the image depending on the location of the reference block within the image.

For example, the similarity metric is a sum of absolute differences or a sum of square differences.

Each of the multiple subblocks includes at least one image sample. A subblock may have a form of a sample row, sample column, square area of adjacent samples, or rectangular area of samples. Different subblocks of the reference block may have the same or different respective forms and sizes.

The method may include accessing an external storage, the storage storing, for the reference block, the positions of K best-matching blocks within the search area in association with the values of the similarity measure calculated between the respective K best-matching blocks and the reference block.

The filtering step is advantageously performing collaborative filtering of the reference block using the K best-matching blocks as patches.

According to an aspect of the disclosure, a method is provided for encoding an image comprising the steps of: performing image compression and generating a bitstream including the coded image; performing image reconstruction of the compressed image; and image filtering of the reconstructed image as described above.

According to another aspect of the disclosure, a method is provided for decoding an image from a bitstream comprising the steps of: extracting from the bitstream portions corresponding to a compressed image to be decoded; performing image reconstruction of the compressed image; and filtering of the reconstructed image as described above.

According to an embodiment, a non-transitory computer-readable storage medium is provided storing therein instructions which, when executed on a computer or processor or a processing circuitry, performs the steps of any of the above described methods.

### BRIEF DESCRIPTION OF DRAWINGS

In the following, exemplary embodiments are described in more detail with reference to the attached figures and drawings, in which:

FIG. 1 is a schematic drawing of block-matching to find a single best-matching block for a reference block.

FIG. 2 is a block diagram showing an exemplary structure of a video encoder.

FIG. 3 is a block diagram showing an exemplary structure of a video decoder.

FIG. 4 is a schematic drawing, illustrating the principle of collaborative filtering, using a set of block-matching patches with best similarity to a reference block.

FIG. 5 is a schematic drawing illustrating block-matching for finding a best-matching block for a reference block on a subblock basis.

FIG. 6 is a flow diagram illustrating the steps of a subblock-iterative block-matching to find K-best matching blocks for a reference block.

### DETAILED DESCRIPTION OF EMBODIMENTS

The present disclosure provides an efficient implementation of block-based filtering using K best-matching blocks for each filtered block.

In particular, the present disclosure provides a low complexity implementation of a collaborative filter particularly suitable for lossy video codecs. The collaborative filtering may be used as in-loop filtering to filter the prediction signal and/or as a post filtering to filter the signal to be output as the decoded image signal. However, it is noted that the present disclosure may still be used also for encoding and decoding of still images and not necessarily video images only.

According to an exemplary design, a reconstructed video frame is divided into a set of small macro-blocks and then each macro-block is filtered by the collaborative filter. For collaborative filtering, for each base macro-block (e.g., reference block) a set of spatial macro-blocks similar to the base macro-block is determined, based on an efficient block matching method. According to this procedure, for each offset (e.g., spatial displacement) from the M*M possible offset candidates within a M*M square search window, a SAD between the base and shifted macro-blocks is calculated and best K<M*M offset candidates with minimal SAD are selected. These K offset candidates are then used for collaborative filtering of the base macro-block.

The fast block matching method allows to dramatically decrease the number of pixels, which should be used for SAD calculation for K best candidate search, in respect to a full search algorithm (e.g., when all pixels inside the macro-block are used for SAD calculation). The proposed method achieves significant complexity reduction without any coding gain loss.

The simulation shows that the proposed method reduces the complexity of the block matching procedure by 1.5-2 times without any coding gain loss. Thus, embodiments of the disclosure are particularly suitable for collaborative filtering, because it allows a fast search for several local minima instead of a single one global minimum.

According to the present disclosure, finding of a set of K-best image patches within a set of (reconstructed) image blocks, partitioning a (reconstructed) frame, is performed on a subblock basis in conjunction with a threshold-based criteria to stop the search for the remaining subblocks. Such subblock-based matching of image blocks accelerates the search for multiple image blocks with spatial similarity to their reference image block within a frame, which are further used in the filtering of images, exploiting at least two similar block-images.

The present disclosure provides an early termination of the fast-search block-matching, by performing a subblock-based iterative calculation of a similarity based on a similarity measure between a block and a reference block, and terminating the iteration for the remaining subblocks, if the similarity measure is lower than a threshold. Such a termination-based block-matching procedure for fast finding a set of K-best blocks (e.g., patches for collaborative filtering) within a search area of a reference block is critical, since at least two image blocks with similarity to a reference block are required to perform collaborative filtering. These sets of K-best patches for each image block within a (reconstructed) image frame are used for further processing of still image or video image coding and decoding. In the following, exemplary video coder and decoder are described, which can implement such early-termination subblock-iterative fast block-matching according to the present disclosure.

The present disclosure may be advantageously employed in the coding and decoding of image and/or video and, in particular, to the early termination of the fast-search processing for finding multiple best-matched image blocks within reconstructed frames, needed in collaborative filtering.

According to an embodiment of the disclosure, an apparatus is provided for video coding and for encoding or decoding a frame of a video.

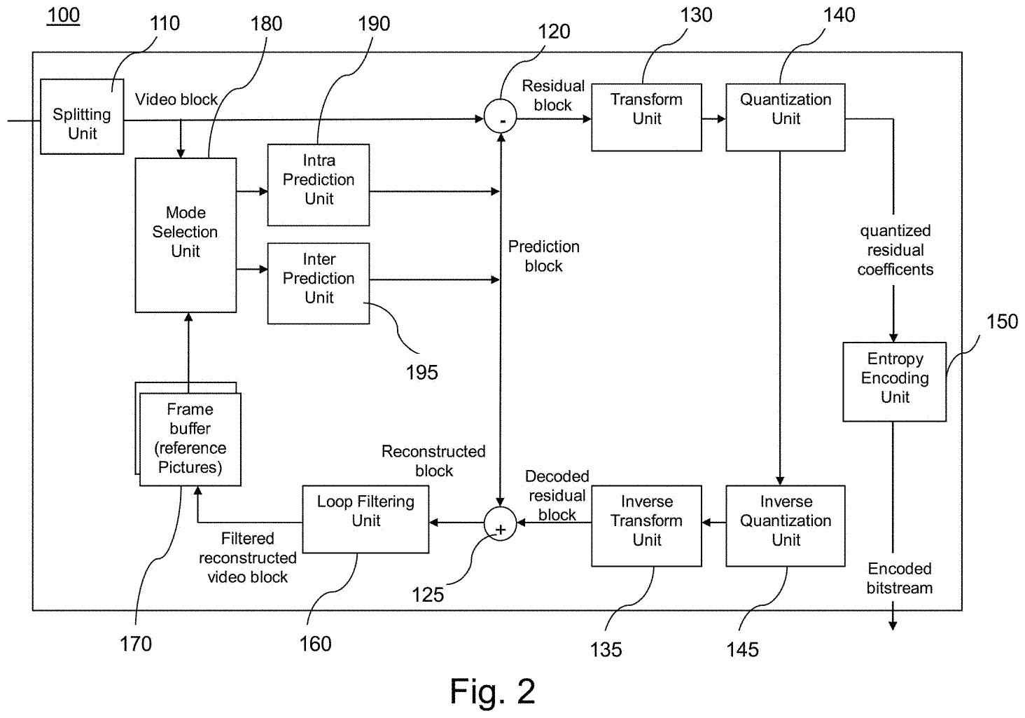

FIG. 2 shows an encoder 100 which comprises an input for receiving input blocks of frames or pictures of a video stream and an output for providing an encoded video bitstream. The term “frame” in this disclosure is used as a synonym for picture. However, it is noted that the present disclosure is also applicable to fields in case interlacing is applied. In general, a picture includes m times n pixels. These correspond to image samples and may each comprise one or more color components. For the sake of simplicity, the following description refers to pixels meaning samples of luminance. However, it is noted that the splitting approach of the present disclosure can be applied to any color component including chrominance or components of a color space such as RGB or the like. On the other hand, it may be beneficial to perform splitting for only one component and to apply the determined splitting to more (or all) remaining components.

The encoder 100 is configured to apply partitioning, prediction, transformation, quantization, and entropy coding to the video stream.

In a splitting unit 110, the input video frame is further split before coding. The blocks to be coded do not necessarily have the same size. One picture may include blocks of different sizes and the block rasters of different pictures of video sequence may also differ. In particular, each video image (e.g., picture) is at first subdivided into CTUs of the same fixed size. The CTU size may be fixed and predefined, for instance in a standard. In HEVC, size of 64×64 is used. However, the present disclosure is not limited to standardized and fixed sizes. It may be advantageous to provide a CTU size which may be set at the encoder and provided as a signaling parameter within the bitstream. For instance, different CTU sizes may be beneficial for the respective different picture sizes and/or content types. The CTU size may be signaled on any signaling level, for instance, it may be common for the entire video sequence or for its parts (i.e. a plurality of pictures) or individually per picture. Correspondingly, it may be signaled, for instance within a Picture Parameter Set, PPS or within a Sequence Parameter Set, SPS or within a Video Parameter Set, VPS which are known from the current codecs (H.264/AVC, H.265/HEVC) or similar parameter sets. Alternatively, it may be specified in a slice header or at any other level. The CTU size may take values different from 64×64. It may for instance be 128×128 samples large. In general, in order to perform hierarchic splitting by binary-tree of quad-tree, it may be beneficial to provide a CTU size which is a power of two, i.e. in the format of 2\hat{ }n with n being an integer larger than 2.

The subdivision of the chroma CTBs is in HEVC always aligned with that of the respective luma CTBs. It is noted that the present disclosure may handle the chroma components in the same way, but is not limited thereto. There may also be an independent splitting of different color components.

After performing the image splitting in the splitting unit 110, the transformation, quantization, and entropy coding are carried out respectively by a transform unit 130, a quantization unit 140 and an entropy encoding unit 150 so as to generate as an output the encoded video bitstream.

The video stream may include a plurality of frames. The blocks of, for example, the first frame of the video stream are intra coded by means of an intra-prediction unit 190. An intra frame is coded using information from that frame only, so that it can be decoded independently from other frames. An intra frame can thus provide an entry point in the bitstream, e.g., for random access. Blocks of other frames of the video stream may be inter-coded by means of an inter prediction unit 195: each block of an inter-coded frame is predicted from a block in another frame (e.g., reference frame), e.g., a previously coded frame. A mode selection unit 180 is configured to select whether a block of a frame is to be intra predicted or inter predicted, i.e. whether it will be processed by the intra prediction unit 190 or the inter-prediction unit 195. The mode selection unit 180 also controls the parameters of intra of inter prediction. In order to enable refreshing of the image information, an inter-coded frame may comprise not only inter coded blocks, but also one or more intra coded blocks. Intra frames, in contrast, contain only intra coded and no inter coded blocks. Intra frames may be inserted in the video sequence (e.g., at regularly, that is, each time after a certain number of inter frames) in order to provide entry points for decoding, i.e. points where the decoder can start decoding without using information from preceding frames.

The intra prediction unit 190 is a block prediction unit. For performing spatial or temporal prediction, the coded blocks may be further processed by an inverse quantization unit 145, and an inverse transform unit 135. After reconstruction of the block by a reconstructor 125 a loop filtering unit 160 may be applied to further improve the quality of the decoded image. The reconstructor 125 adds the decoded residuals to the predictor to obtain reconstructed block. The filtered blocks then form the reference frames that are then stored in a frame buffer 170. Such decoding loop (e.g., decoder) at the encoder side provides the advantage of producing reference frames which are the same as the reference pictures reconstructed at the decoder side. Accordingly, the encoder and decoder side operate in a corresponding manner. The term “reconstruction” here refers to obtaining the reconstructed block by adding the decoded residual block to the prediction block.

The inter-prediction unit 195 receives as an input a block of a current frame or picture to be inter coded and one or several reference frames or pictures from the frame buffer 170. Motion estimation and motion compensation are performed by the inter prediction unit 195. The motion estimation is used to obtain a motion vector and a reference frame, e.g., based on a cost function. The motion compensation then describes a current block of the current frame in terms of the translation of a reference block of the reference frame to the current frame, i.e. by a motion vector. The inter prediction unit 195 selects a prediction block (i.e., a predictor) for the current block from among a set of candidate blocks (i.e., candidate predictors) in the one or several reference frames such that the prediction block minimizes the cost function. In other words, a candidate block for which the cost function is minimum will be used as the prediction block for the current block.

For instance, the cost function may be a measure of a difference between the current block and the candidate block, i.e. a measure of the residual of the current block with respect to the candidate block. For example, the cost function may be a sum of absolute differences (SAD) between all pixels (e.g., samples) of the current block and all pixels of the candidate block in the candidate reference picture. However, in general, any similarity metric may be employed, such as mean square error (MSE) or structural similarity metric (SSIM).

However, the cost function may also be the number of bits that are necessary to code such inter-block and/or distortion resulting from such coding. Thus, a rate-distortion optimization procedure may be used to decide on the motion vector selection and/or in general on the encoding parameters such as whether to use inter or intra prediction for a block and with which settings.

The intra prediction unit 190 receives as an input a block of a current frame or picture to be intra coded and one or several reference samples from an already reconstructed area of the current frame. The intra prediction then describes pixels of a current block of the current frame in terms of a function of reference samples of the current frame. The intra prediction unit 190 outputs a prediction block for the current block, wherein said prediction block advantageously minimizes the difference between the current block to be coded and its prediction block, i.e., it minimizes the residual block. The minimization of the residual block can be based, e.g., on a rate-distortion optimization procedure. In particular, the prediction block is obtained as a directional interpolation of the reference samples. The direction may be determined by the rate-distortion optimization and/or by calculating a similarity measure as mentioned above in connection with inter-prediction.

The difference between the current block and its prediction, i.e. the residual block, is then transformed by the transform unit 130. The transform coefficients are quantized by the quantization unit 140 and entropy coded by the entropy encoding unit 150. The thus generated encoded video bitstream comprises intra coded blocks and inter coded blocks and the corresponding signaling (e.g., such as the mode indication, indication of the motion vector, and/or intra-prediction direction). The transform unit 130 may apply a linear transformation such as a discrete Fourier transformation (DFT) or a discrete cosine transformation (DCT). Such transformation into the spatial frequency domain provides the advantage that the resulting coefficients have typically higher values in the lower frequencies. Thus, after an effective coefficient scanning (such as zig-zag), and quantization, the resulting sequence of values has typically some larger values at the beginning and ends with a run of zeros. This enables further efficient coding. The quantization unit 140 performs a lossy compression by reducing the resolution of the coefficient values. Entropy coding unit 150 then assigns binary codewords to coefficient values. The codewords are written to a bitstream referred to as the encoded bitstream. The entropy coder also codes the signaling information (not explicitly shown in FIG. 2) which may include coding according to the splitting flag syntax shown above.

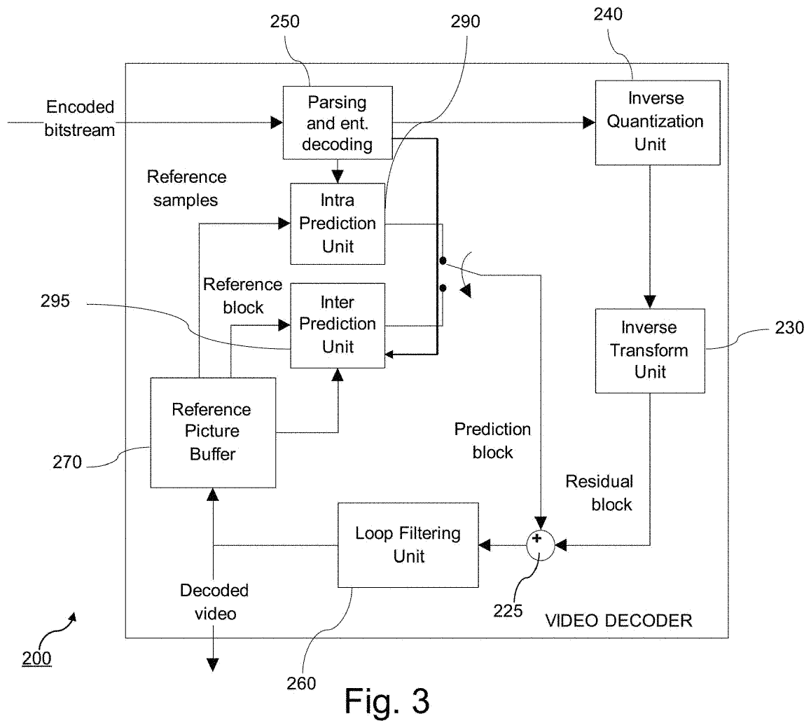

FIG. 3 shows an example of a video decoder 200. The video decoder 200 comprises particularly a reference picture buffer 270 and an intra-prediction unit 290, which is a block prediction unit. The reference picture buffer 270 is configured to store at least one reference frame reconstructed from the encoded video bitstream of the encoded video bitstream. The intra prediction unit 290 is configured to generate a prediction block, which is an estimate of the block to be decoded. The intra prediction unit 290 is configured to generate this prediction based on reference samples that are obtained from the reference picture buffer 270.

The decoder 200 is configured to decode the encoded video bitstream generated by the video encoder 100, and preferably both the decoder 200 and the encoder 100 generate identical predictions for the respective block to be encoded/decoded. The features of the reference picture buffer 270 and the intra prediction unit 290 are similar to the features of the reference picture buffer 170 and the intra prediction unit 190 of FIG. 2.

The video decoder 200 comprises further units that are also present in the video encoder 100 like, e.g., an inverse quantization unit 240, an inverse transform unit 230, and a loop filtering unit 260, which respectively correspond to the inverse quantization unit 140, the inverse transform unit 150, and the loop filtering unit 160 of the video coder 100.

A bitstream parsing and entropy decoding unit 250 is configured to parse and decode the received encoded video bitstream to obtain quantized residual transform coefficients and signaling information. The quantized residual transform coefficients are fed to the inverse quantization unit 240 and an inverse transform unit 230 to generate a residual block. The residual block is added to a prediction block in a reconstructor 225 and the resulting sum is fed to the loop filtering unit 260 to obtain a decoded video block. Frames of the decoded video can be stored in the reference picture buffer 270 and serve as reference frames for inter prediction. The signaling information parsed and decoded from the bitstream may generally include control information related to frame partitioning. In order to further correctly parse and decode the image, the control information is used to recover splitting of the image into coding units in order to correctly assign the following decoded data to the respective coding units.

Generally, the filtering units 160 and 260 of FIGS. 2 and 3 can implement the filtering using K best matching blocks as will be described in detail in the following.

The bitstream parsing and entropy decoding unit 250 receives as its input the encoded bitstream. The bitstream may first be parsed, i.e. the signaling parameters and the residuals are extracted from the bitstream. The syntax and semantic of the bitstream may be defined by a standard so that the encoders and decoders may work in an interoperable manner. The signaling parameters may also include some filter settings for the collaborative filter, such as number of patches (e.g., K) to be used and/or other settings, as describe further below

The video coding apparatus performs in particular collaborative filtering of a reconstructed frame, based on multiple similar spatial areas of reconstructed frame(s).

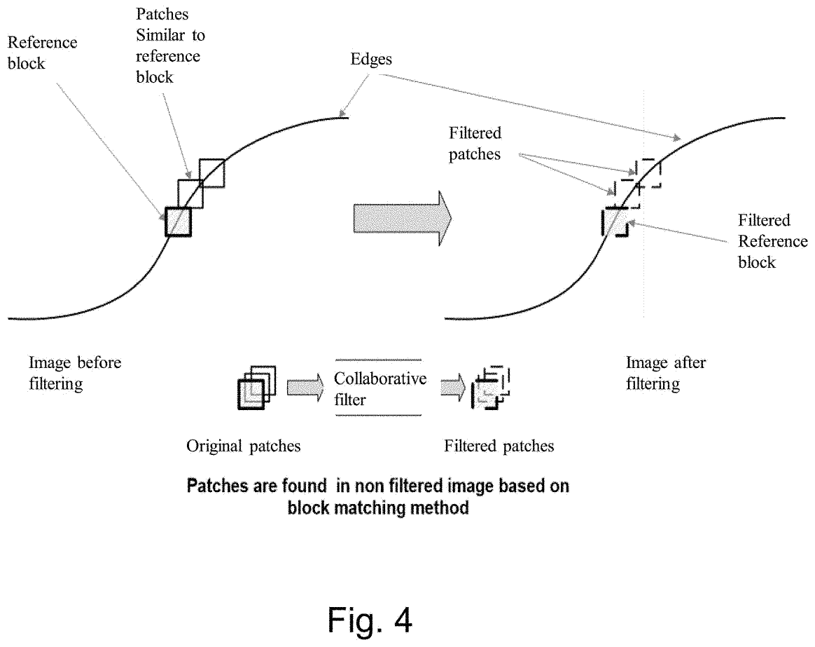

FIG. 4 illustrates the principle of the collaborative filtering of an image including an edge, based on a set of image blocks, referred to as original patches. The left part of FIG. 4 shows the image before filtering, along with a set of unfiltered reconstructed blocks. The set of these unfiltered reconstructed blocks consists of the reference block (shown in FIG. 4 as a solid square) and a set of neighboring blocks (not necessarily directly neighboring, but rather located in the neighborhood and marked in FIG. 4 by a dashed square) around the reference block, having similar spatial image areas (e.g., best patches). In the example of FIG. 4, there are two (e.g., K=2) of these neighboring blocks with similarity to the reference block. However, before filtering, these best patches around the reference block must be first found within the image (e.g., reconstructed frame) or a search region being a subset of image samples, which is accomplished via a block-matching technique. Once a set of patches is found, the set of the reconstructed blocks similar to the reference block are jointly filtered by use of a collaborative filter, which provides as output both the filtered reconstructed reference block and/or its filtered set of similar (e.g., K best-matching) blocks.

Clearly, the provision for the sets of similar blocks impacts the performance of the filter and the computational complexity of the filtering.

One of the directions to improve the complexity of the block matching method has been to reduce the number of pixels inside a macro-block used for SAD calculation. In HEVC, the single best matching candidate is found in a reference frame by a Fast Computational Full Search (FCFS) method. This approach allows decreasing the number of pixels, which should be used for SAD calculation in respect to a full search algorithm, using all pixels inside the macro-block without any coding loss. The FCFS algorithm consists of the following steps:

Step 1: Compute the sum of absolute difference (SADmin) between the current macro-block MB and the macro-block at the same location in the reference frame. Consider this value to be the minimum SAD.

Step 2: Compute the sum of absolute difference between pixels of next candidate block and the current block. If the new value exceeds SADmin then stop computing the SAD for the rest of the pixels and move to step 3. Otherwise, continue the process to compute SAD for the rest of the pixels then move to step 4.

Step 3: Move to the next macro-block in the search area and go back to step 2.

Step 4: Assign the new SAD from step 2 to the SADmin and move to the next candidate MB then go back to step 2.

Step 5: The last SADmin will give the matching macro-block.

While the FCFS approach has a lower complexity, it only provides one single best-matching block and, hence, cannot be used for collaborative filtering, which requires at least two (e.g., K>1) best patches. For collaborative filtering, the macro-blocks found from one side should be similar to the reference macro-block, but from other side these macro-blocks should be different in respect to each other.

According to the present disclosure, a fast block-matching technique is provided to find a set of K-best image patches for a reference block by searching positions of K best matching blocks within a search region of reconstructed frame(s) with K being an integer larger than one.

In particular, according to an embodiment, an apparatus (e.g., a filtering device) is provided for filtering a reference block based on K best-matching blocks within a search area of an image, K being an integer larger than one. The apparatus comprises a processing circuitry which in operation performs the search for the K best candidates and the filtering. The processing circuitry may be one or more pieces of hardware such as a processor or more processor, an ASIC or FPGA or a combination of any of them. The circuitry may be configured to perform the processing described above either by hardware design and/or hardware programming and/or by software programming. Thus, the processing circuitry may also be implemented as a general purpose processor with the corresponding software thereon. Alternatively, the processing circuitry may be completely implemented in hardware.

The reference block is any image portion including more than two pixels. Typically, a reference block will have a rectangular or square shape. It is noted that the K best-matching blocks may be located in the same image as the reference block. Accordingly, the filtering may be applied to still images as well as to separate reconstructed frames of a video sequence (at the encoder and/or decoder). However, the present disclosure is not limited to reference blocks being from the same image as the patches. It may be advantageous to use also patches from previously reconstructed frames of a video sequence.

Thus, benefit can be achieved for still images to which the filtering is applied. However, even more improvement can be achieved for video, because for a reference block filtering similar blocks not only from the current frame (same as reference block) but also similar blocks from a previous decoded frame may be used. Using previous decoded frames allows not only to improve quality of filtering but also to additionally decrease complexity, because in modern video codecs, information about block similarity in different frames (motion vectors) is already transmitted. It allows performing a very good pre-selection of the tested offsets. Thus, in a video case, best matching blocks can be found in different decoded frames.

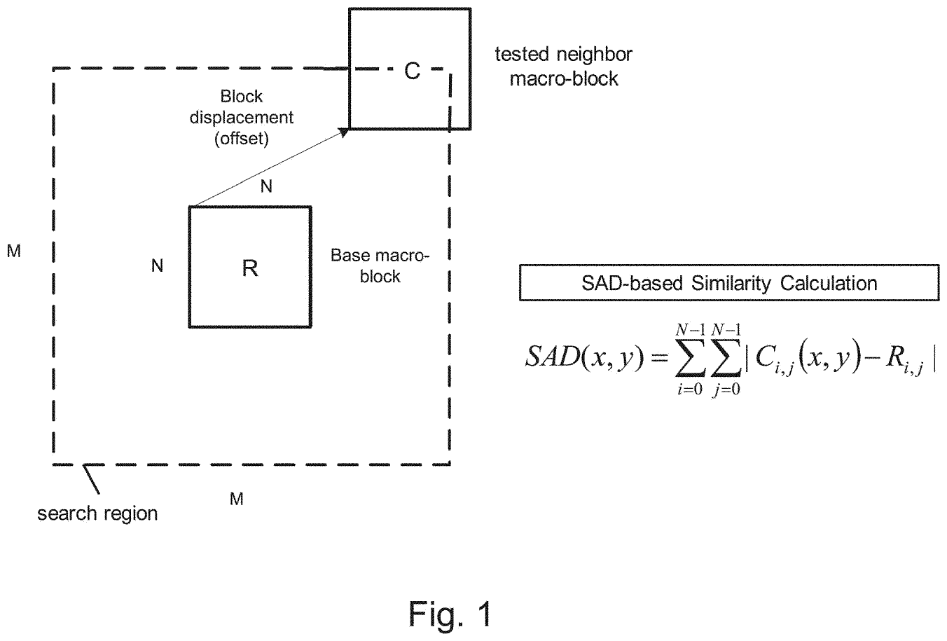

The search area can be the entire image (e.g., a current image including the reference block or a previously reconstructed image different from the image in which the reference block is located). However, in order to further reduce the complexity of the filtering, the search area may be advantageously defined relatively to the position of the reference block within the image including the reference block. For instance, the search area may be defined as described above with reference to FIG. 1 as an M×M region around the position of the reference block within the image. Here, the position of the reference block may be specified either by the top left corner of the reference block or by the center of the block.

It is noted that the present disclosure is not limited to the form and shape of the search area. In general, the search area may include integer sample positions. On the other hand, also fractional (e.g., interpolated) positions may be included in the search area. This may provide better accuracy. In order to reduce further the number of computations, the search space may include only every second or third integer pixel position or the like. In general, the search space may be defined as any subset of sample positions and does not have to include all adjacent samples. Thus, the search area (i.e., the search space) does not have to be rectangular or square. It may be advantageous to provide a diamond (e.g., a rhombus) shaped search space.

The apparatus for image filtering (e.g., apparatus 160 and/or apparatus 260) includes circuitry which is configured to divide the reference block into multiple non-overlapping (i.e., disjoint) subblocks and to perform calculation of a similarity measure between the reference block and a block at a current position within the search area iteratively on a subblock basis, wherein said calculation is terminated, if the similarity measure in a current iteration indicates similarity lower than a predetermined threshold value.

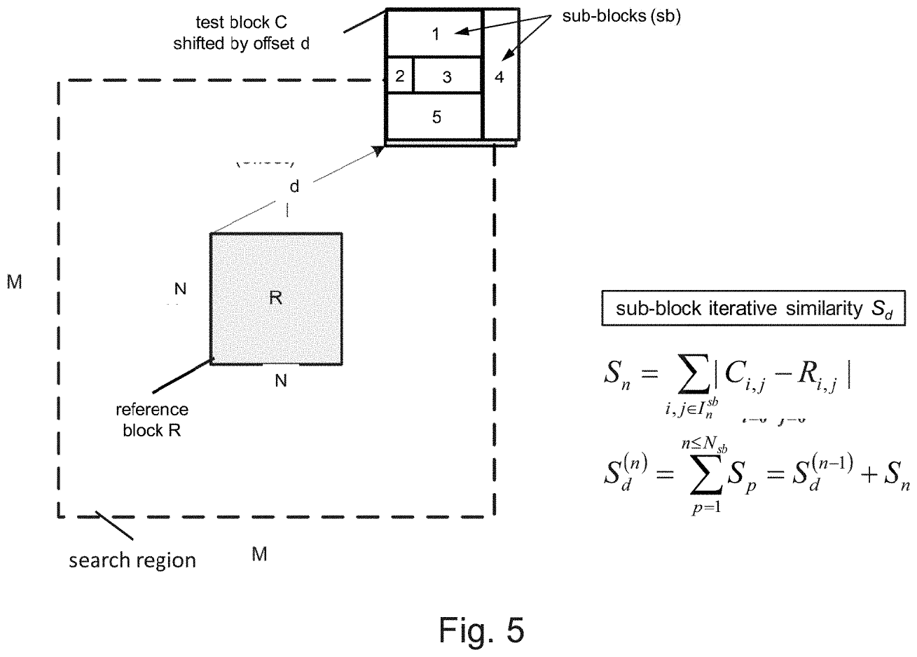

FIG. 5 illustrates a reference block R with the size N×N and a search region with the size M×M surrounding the reference block in the same image. The reference block can have the shape of a square, a rectangle, or of any general form and size, which can be e.g. predefined by a standard or configurable within certain range.

The block-matching approach of some embodiments of the present disclosure includes dividing the reference block R into multiple non-overlapping subblocks, as shown in FIG. 5 for the currently tested block C, which may also be referred to as candidate block. In one embodiment of the present disclosure, one or more subblocks has/have a form of any of a sample row, sample column, square, or rectangle. In general, these basic forms can be taken in any combination thereof to implement a set of non-overlapping subblocks partitioning block C. FIG. 5 shows subdividing of the currently tested candidate block C into five differently sized rectangular partitions. Block R is to be subdivided in the same way in order to iteratively calculate the similarity measure. In other words, the location and form of the subblocks in both blocks R and C is the same.

Some simple and exemplary subdivisions of the reference R and candidate C block into subblocks are:
Each subblock is a respective entire line (either row or column) of pixels of the blocks R and C. The term “respective” means that the subblocks are equally defined in block R (i.e., reference block) and block C (i.e., candidate block), i.e. the subblocks have the same spatial position in both blocks. In this case, each subblock is an entire line in block C and block R.
Each subblock is a respective multiple of lines of pixels of the blocks R and C.
Each subblock is a rectangle with both sides smaller than the size of the blocks R and C, the subblocks have the same size.
Each subblock is a square (in particular beneficial for square reference and candidate block), the subblocks have the same size.

As mentioned above, the subblocks do not have to have the same size. However, the same size of the subblocks reduces the complexity of the subdivision and thus filtering.

The similarity between the reference block R and a block C at a current position within the search region is then calculated iteratively subblock by subblock.

In one embodiment of the present disclosure, the similarity is calculated as the sum of absolute differences (SAD). The similarity can be calculated, based on alternative similarity measures, including sum of squared differences (SSD) or a correlation (e.g. cross-correlation or correlation coefficient) between the reference block samples and the samples of the candidate block C. However, it is noted that any other similarity measure may be used as well as an alternative for the present disclosure.

A high/low similarity, used to classify the quality of the, e.g., spatial likeness between the reference block and a tested block C, is indicated by a corresponding low/high value of the SAD or SSD. In other words, the larger the SAD or SSD, the lower is the similarity between the subblocks of the blocks R and C. In turn, when using correlation (or correlation coefficients) as similarity measure, the higher the correlation value (or value of the correlation coefficient), the higher is the similarity.

If the similarity measure at the current subblock iteration indicates a similarity lower than a predetermined threshold value, the similarity calculation at this iteration step is terminated; otherwise the iteration continues with the next subblock. In other words, the similarity measure is calculated step-wisely. In the first step, similarity between a first subblock of blocks R and C(x, y) is calculated, x and y representing position within the search region, i.e. specify the candidate block C(x, y). For instance if the similarity is measured by means of summing a function or differences between samples of blocks R and C(x, y), in the first step only a sum of a function (e.g., absolute value, square, or the like) of differences for the samples of the first subblock is calculated. If already this sum exceeds the threshold, it is clear that summing up further function of differences from the remaining subblocks would only increase the dissimilarity. Accordingly, the calculation of the further differences (between the remaining subblocks) is omitted for the candidate block C in the position x, y. Instead, a new position such as (x, y+1) or (x+1, y) or the like is tested (depending on the sequence of testing the positions). If, on the other hand, in the first step, the sum of the function of differences does not exceed the threshold, in the second step, the sum is further adding a sum of function of differences between R and C(x, y) in the second subblock. Again, if the updated sum exceeds the threshold, further calculation is stopped and a new position (e.g., a new candidate block) is tested. Otherwise, the sum is updated by calculating function of differences for the next subblock until all subblocks were considered or until the calculation was terminated due to threshold exceeding.

If the similarity measure, calculated for all subblocks with respect to the reference block R and the candidate block C(x, y), indicates a similarity higher than the predetermined threshold value (e.g., a sum of function of differences lower than the corresponding threshold), one candidate for the best patch with similarity to the reference block R is found among the K best-matching blocks. In other words, the tested position x, y is stored as a candidate for the K best positions. The threshold may be updated as will be discussed later. Alternatively, after having tested all positions in the search region, from among the stored candidates, K candidates leading to the highest similarity with the reference block R are chosen.

The above test condition “higher/lower” than the predetermined threshold value did not take into account testing against “equal values”, but is easily absorbed into the test by “greater than or equal” or “less than or equal” and incorporates the case, where the similarity between the reference block and tested block C are the same. Accordingly, the definition of the condition may also include the equality to the threshold.

After determining the K best-matching blocks, the reference block and possibly also the K best-matching blocks are filtered using the K best-matching blocks located in the respective positions.

An advantage of this approach is to avoid unnecessary calculations of the similarity measure over all subblocks, covering the whole reference block. In this manner, positions of image blocks within the search area are dismissed early on during the block-matching search procedure, so that one can quickly turn towards testing other possible block positions.

According to one embodiment of the present disclosure, the processing circuitry is configured to update the threshold by setting said threshold to a value corresponding to a function of the similarity measure value calculated between the reference block and the worst-matching block among the K best-matching blocks.

In other words, in order to maintain the storage requirements low, there may be storage reserved for storing the K best-matching blocks. It is beneficial not to store the entire blocks but rather the positions of the K best-matching blocks within the image corresponding to the search space. If the K best-matching blocks are searched in different images, image identification may also be stored for each of the K best-matching blocks. Moreover, advantageously, the K positions of the respective best-matching blocks are stored together with the similarity measure. Thus, during the testing of the candidate positions from the search region, the K stored positions are updated so that when the entire search region is searched, the stored K positions correspond to the K best-matching blocks.

In particular, at the beginning, the threshold may be initialized with a value which corresponds to a minimum similarity (e.g. maximum SAD) acceptable for use as a patch in collaborative filtering. This threshold value may be determined by testing. Then, as long as there is still space among the K so far (i.e., currently determined) best positions, the blocks which have similarity higher than the threshold (e.g., a SAD lower than threshold) are stored until the K places in the storage are full. Then, the threshold is updated to correspond to the SAD of the block among the K best-matching blocks, which has the lowest similarity to the reference block. This makes sure that wherever a better block is tested, the worst candidate stored so far is replaced and the threshold is adapted accordingly.

The term “worst-matching block” among the K blocks denotes the stored block with the lowest similarity to the reference block among the K blocks. Correspondingly, the worst position among the positions of the already found K best-matching blocks corresponds to the worst-matching block. Replacing always the worst of the K blocks ensures that after testing all the positions, the K blocks are the K best-matching blocks. It is noted that replacing worse of the K blocks may also help finding some good patches. Here “worse” means that the worse block is less similar to the reference block than the currently tested block.

The above description has been provided for one reference block. However, in order to filter an image, this approach can be repeated for all blocks which are to be filtered. In particular, an image may be first subdivided into reference blocks. For each block it may be decided or determined whether or not the filtering is to be applied. Then, for such reference blocks for which the filtering is to be applied the above described (collaborative) filtering is applied, including the search for the best matches and filtering.

The image subdivision may be performed by dividing the image into non-overlapping equally-sized square blocks of a size, for instance 16×16, 8×8 or 4×4 or the like. The size may depend on the image resolution or it may be determined by rate-distortion or rate-distortion-complexity optimization. However, these are only some examples. In general, any other block sizes may be employed and the blocks may also differ in size. For instance, a hierarchic partitioning may also be used. The blocks do not have to be square. They can have sides with different sizes or may even be non-rectangular shaped. Nevertheless, square and rectangular shapes typically provide for simple implementation.

If the filtering is applied as a part of video coding and decoding, the subdivision of the image into reference blocks to be filtered may follow the partitioning of the image for the purpose of coding, i.e. partitioning of the image into the CTUs and CUs as described above with reference to FIGS. 2 and 3. This may be beneficial, since such partitioning usually already reflects the picture character so that smooth blocks have larger blocks and more complex image portions are divided into smaller blocks. However, it is noted that the subdivision of the image into the blocks may also be performed independently of the underlying partitioning for block coding purposes. The subdivision may be configurable, i.e. determined at the encoder by user or the encoder and signaled within the bitstream for the decoder.

The threshold mentioned above is used for comparison with the similarity measure calculated for block R and C or their parts (e.g., subblocks). Thus, the threshold can be set directly to a predefined value of the similarity measure. However, the threshold may alternatively be a function of the similarity measure including, for instance, image clipping or rounding, quantizing or the like. The similarity measures of the respective K currently found best-matching blocks can also be more efficiently stored when their value is quantized, rounded or clipped or the like.

The initial threshold may be determined based on a quantization step applied to quantize the image or the quantization noise of the image (e.g., based on comparing an original and a reconstructed frame). For instance, the more coarse an image is quantized (i.e., the larger quantization step size, for example, represented by a higher quantization parameter QP), the higher the threshold to be chosen or applied. The quantization noise can be also derived from the quantization parameter QP, as transferred already from the encoder to the decoder side in lossy video codec, for example. Alternatively, the quantization noise may be measured at the encoder and indicated to the decoder.

According to one embodiment of the disclosure, the processing unit (e.g., processing circuitry) is configured to perform the similarity calculation in a loop for each position within the search area corresponding to reference block.

This loop over all positions within the search region around the reference block R, as shown in FIG. 5, is performed throughout the block-matching, irrespective of whether the subblock iteration is early terminated or not.

The positions within the search area can be located in an integer sample distance from each other. However, alternatively, fractional sample distances may define the search region positions, such as half-pel or quarter-pel.

In general, the filtering may be applied only to luminance and chrominances may remain unfiltered. Alternatively, the K best-matching blocks may be found only for luminance component of the reference block and the search region, but the filtering may be applied not only for luminance component but also for one or more or all chrominance components. Alternatively, each component of luma and chroma can be handled separately. It is noted that the above described filtering including the search of the K best-matching blocks may be applied to one or more components of any color space such as RGB, RGBW, and not only to YUV or YCbCr or the like.

The search area of the image around the position of the reference block can include the entire image or can adopt the shape of a square or rectangle. The advantage of such shapes is their simplicity; they can be defined easily by a relative position to the reference block and/or size in x and/or y direction. However, the disclosure is not limited to any particular shape of the search region and in general, the search region may also be selected with regard to the image content. For example, pixel regions along one edge or multiple edges of the reference block may be provided as search regions. Further options for search shapes can comprise a pixel group with a skew orientation (e.g., pixel diagonals), by which K-best matching block with certain pattern orientations can be searched.

In other words, the processing circuitry may be configured to pre-select the positions belonging to the search area based on properties of the image inside the search area. For example, if the search area includes already filtered blocks, then the edge directions of these blocks are already known so that the positions to be tested may be selected along these directions only. The edge direction may also be known if the blocks are intra-coded blocks during video coding or decoding. The directional prediction mode may be used to limit the search in the direction of the edge.

Moreover, a pre-selection can be based, for example, on similarity knowledge, i.e., similarity data, as a result of prior search(es) for K-best patches and stored in a storage. These similarity data can be used to a priori exclude/include far or near-ranging search pixel regions. Another option can be to pre-select positions according to specific image features, such as a prior known image patterns with possible orientations, luma, or chroma image content. For example, a pre-selection of the positions, which have been classified according to their luma content. The post-selection, i.e., the following block-matching can be continued by using these luma-based patches to define the search region and perform the block-matching based on the chroma content.

While the complexity of the block-matching approach of embodiments of the present disclosure is already lower than the one of the prior art, the option to pre-select the tested positions reduces the number of positions (e.g., offsets) of the search area and, hence, the complexity of block-matching.

According to any of the above described examples and implementations, the reference block and the search area are located within the same image, and the processing unit in operation determines the location of the search area within the image depending on the location of the reference block within the image. This approach is also suitable for still images. However, it may also be used for video coding and decoding and applied to any type of frame (e.g., I, P, B or the like) after reconstruction.

According to any of the above described examples and implementations, each of the multiple subblocks includes at least one image sample. Thus, in one example each of the subblocks corresponds to a single sample. In another example, at least one of subblocks has a size of a single sample while some other subblocks have different sizes/shapes. Smaller subblocks enable an early termination of the block matching for one candidate which reduces the complexity. On the other hand, the number of comparisons to be done for a large amount off subblocks increases the complexity. Accordingly, it may be advantageous as in some embodiments of the disclosure, to provide a size of a subblock as a multiple of samples.

A subblock can have a form of any of a sample row, sample column, square area of adjacent samples, and rectangular area of samples. Alternatively, the subblock partitioning can comprise an inhomogeneous and/or irregular tilling of the reference block with the above shapes taken in any combination, covering the entire reference block in a non-overlapping manner. For example, such shapes can consist of a chessboard (e.g., black-white block partitioning), a maze, or the like.

According to any of the above described examples and implementations, a storage or means for accessing a storage (e.g., internal or external to the filtering device) may be part of the filtering device. The storage stores, for the reference block, the positions of K best-matching blocks within the search area in association with the values of the similarity measure calculated between the respective K best-matching blocks and the reference block. It is noted that the storage may be used to store temporary K best-matching bocks as described above, i.e. K best-matching blocks which may be updated with each step corresponding to similarity calculation in one candidate position.

According to some embodiments of the present disclosure, the storage storing the similarity data (e.g., positions and calculated similarity measures) of the K-best matching blocks for the reference block consists of a local buffer, registers, cache memory, any memory such as an on-Chip RAM (e.g., IRAM, DRAM, SRAM or the like) or a storage drive. The storage may be intern or extern with respect to the processing circuitry. If the storage is extern, then the processing circuitry may be configured to access the data in the storage.

However, it is noted that the present disclosure is not limited to storing only the K currently best-matching blocks (e.g., storing their positions). The similarity data being stored in the storage may further contain, for example, similarity data of previous searches for K-best block-matching, which can be used as input data for pre-selection (e.g., of positions) prior to launching a new search for K-best matching blocks.

According to any of the above described examples and implementations, the apparatus comprises a filter configured to perform collaborative filtering of the reference block using the K best-matching blocks as patches. It is noted that the present disclosure is not only applicable to collaborative filtering as known from the prior art cited above, but to any other form of filtering which makes use of K best-matching blocks.

According to an embodiment, an encoder is provided for encoding an image. The image may be a still image and the encoder may be a still image encoder. Alternatively, the encoder is a video encoder such as a hybrid video encoder as described above with reference to FIGS. 2 and 3. However, any other encoder may also embed the filtering as described above as it operates on the reconstructed image/video frame and thus can be applied to the result of any encoder (after reconstruction) or decoder.

The encoder may comprise an image coding unit configured to perform image compression and generating a bitstream including the coded image. Such coding unit may comprise the above mentioned transform unit 130, a quantization unit 140, and/or prediction-related units 180, 190, 195. Moreover, the encoder may include an image reconstruction unit 125 configured to perform image reconstruction of the compressed image, including an image processing of the reconstructed image.

The images generated by the image reconstruction circuitry are further used, after optional filtering by a collaborative filter for example, to generate reference pictures, which corresponds to the application of the filtering as loop-filtering. In other words, these reference pictures (i.e., frames) may be filtered by an in-loop filter and used for the temporal prediction in the video coder and decoder, as illustrated in FIGS. 2 and 3. The in-loop filtering may be performed by a collaborative filter, implying that the in-loop filtering can be only executed after the entire image has been reconstructed, i.e., after the respective reconstructed blocks are available. However, in order to reduce the delay and memory requirements, the filtering may be also performed on a slice basis, i.e. for a separately decodable image portion.

In general, the collaborative filtering may also be performed on a block basis when coding/decoding the corresponding blocks. However, the collaborative filtering by the encoder and decoder can only start, after a certain number of blocks are reconstructed, so that there are some reconstructed image blocks already, belonging to the same image as the reference block. Thus, in an embodiment, the search for K best-matching blocks is performed after a predetermined number of blocks are reconstructed.

However, there is no delay, if the previously reconstructed video frames are used to search for the K best-matching blocks or at least for some of the K best-matching blocks. The search in the previously reconstructed frames is performed in the same way as described above. The search region may be defined relatively to a block in the frame collocated with the reference block in the image in which the reference block is located. Accordingly, the above described filtering and K best-matching block search may be particularly suitable for the video coding and decoding.

As opposed to the encoder, the decoder may perform the above described filtering in addition as post filtering of the decided image to be displayed. The above filtering may be also used only for post-filtering without being used for filtering of reference images.

The term “In-loop filtering” is understood here as filtering of one or more blocks of a reconstructed frame at the encoder and/or decoder, the reconstructed frame being used by temporal prediction (e.g., inter-prediction) as a reference frame.

The term “post filtering” is understood here as a decoder side filtering which filters decoded image to be displayed, rather than reference image. It is noted that there may be situations in which post filter is also used at the encoder, for instance for the purpose of an optimization such as rate-distortion optimization. If post-filter is an adaptive filter, it may be beneficial to determine filter parameters at the encoder and signal them to the decoder which may also require post filter at the encoder side.

According to an embodiment of the disclosure, the encoder according to any of the above described examples and implementations comprises further an optimization unit which in operation performs a rate-complexity-distortion process based on a predefined cost function based on a rate, distortion and number of operations required.

The “Cost” function may be given by:

Cost=MSE+λ₁Rate+λ₂NumOper, (Eq. 2)

MSE=Σₚ₌^{p=P}(Oₚ−Fₚ)², (Eq. 3)

Rate=Function(THR,SubBlockSize), (Eq. 4)

NumOper=Function(THR,SubBlockSize), (Eq. 5)

where “NumOper” refers to the number of operations required for block-matching and filtering, and “Rate” corresponds to the number of bits for the transfer of filter parameters; MSE accounts for the mean square error between the original and filtered reconstructed frame. Lambdal and lambda 2 are weights estimated based on analysis of rate-distortion-complexity curves O stands for original image known at the encoder, F stands for the filtered image, p is an index from 0 to P, and P is the number of samples (e.g., pixels) compared.

The result of the rate-complexity-distortion process is the selection of
the predetermined threshold THR; and/or
size (SublockSize) and/or form of the subblocks for the reference block.

The term “Function” indicates that for each of the values THR and SubBlockSize there is one value of Rate and one value SubBlockSize, which can be determined during filtering process. Different values THR and SubBlockSize are chosen during rate-complexity-distortion process and corresponding values MSE, Rate, NumOper are calculated. Then the values THR and SubBlockSize that have minimal cost are chosen and transferred from encoder to decoder side.

According to another embodiment, a decoder is provided for decoding an image from a bitstream. The bitstream may be a bitstream output from the above mentioned encoder. The image may be a still image or a video image, i.e. the decoder may be a still image decoder or video decoder. The decoder may further comprise a bitstream parser for extracting from the bitstream portions corresponding to a compressed image/video frame to be decoded. An image reconstruction unit is then configured to perform image reconstruction of the compressed image/video frame, including image filtering of the reconstructed image. The reconstructed image can be filtered post- and/or in-loop.

The video encoder and decoder may work according to a standard similar to H.265/HEVC, for instance it may be implemented in a next generation H.266 encoder and decoder.

According to an example, the image is a video image and the apparatus for image processing is a post filter. According to another example, the image is a video image and the apparatus for image processing is an in-loop filter. The in-loop filtering may be performed after the entire frame is reconstructed and before it is used for temporal prediction. This assumes that intra-prediction uses filtered samples of reference images. The proposed filter can be also used to improve the intra-prediction in cases where the filtering is performed sequentially block-by-block. In other words, the in-loop filtering using collaborative filter may be performed on-the-fly, meaning only for those blocks, which are decoded already. In one alternative embodiment, at the beginning of the filtering of the frame, when there are not yet sufficient reconstructed blocks available, patches from other already decoded frames may be taken. Thus, the K best-matching blocks may be searched in the same frame as the location of the reference block as well as in one or more previously reconstructed frames.

The bitstream advantageously includes one or more of:
an indication of quantization noise. This can be used to derive initial threshold and/or the number of patches to be used (K) and/or size (and/or form) of the reference blocks.
an indication of event that quantization noise is derived from quantization parameter QP, used in modern hybrid video codecs. Quantization parameter determines the quantization step size and thus, influences the quantization noise. This indication helps encoder and decoder to derive the initial threshold in the same way.
an indication of the predetermined threshold. This is a simple possibility according to which, the threshold does not have to be derived.
an indication of a size and/or a form of the subblocks,
number, K, of the patched to be used for filtering of a reference block.

The above parameters may be signaled within the SPS, PPS or slice header or some other signaling information container.

The determination may also be implemented by program instructions stored on a computer readable medium which when executed by a computed perform the steps of a method as described above. The computer readable medium can be any medium on which the program is stored such as a DVD, CD, USB (e.g., Flash) drive, hard disc, server storage available via a network, etc.

The encoder and/or decoder may be implemented in various devices including a TV set, set top box, PC, tablet, smartphone, or the like. It may be a software, app implementing the method steps.

Moreover, a method is provided for image processing including determining, for a reference block, positions of K best-matching blocks within a search area of an image, K being an integer larger than one, the method comprising the steps of:

dividing the reference block into multiple non-overlapping subblocks;

performing calculation of a similarity measure between the reference block and a block at a current position within the search area iteratively on a subblock basis, wherein said calculation is terminated, if the similarity measure in current iteration indicates similarity lower than a predetermined threshold value;

including the current position among the positions of K best-matching blocks if the similarity measure calculated for all subblocks of the reference block indicates a similarity higher than the predetermined threshold value wherein the current position is inserted among the position of K best-matching blocks if not all K best matching blocks are found and replace worst (with the lowest similarity) position if K best matching blocks are found already; and

updating the predefined threshold by setting the threshold upon including the current position among the position of K best-matching blocks based on similarity measure value between reference block and worst of K best-matching blocks.

The above method for filtering may be implemented by an encoding method which contains the following steps:

performing image compression and generating a bitstream including the coded image;

performing image reconstruction of the compressed image; and

image filtering of the reconstructed image as described above.

The above method for filtering may be implemented by a decoding method which contains the following steps:

extracting from the bitstream portions corresponding to a compressed image to be decoded;

performing image reconstruction of the compressed image; and

filtering of the reconstructed image as described above.

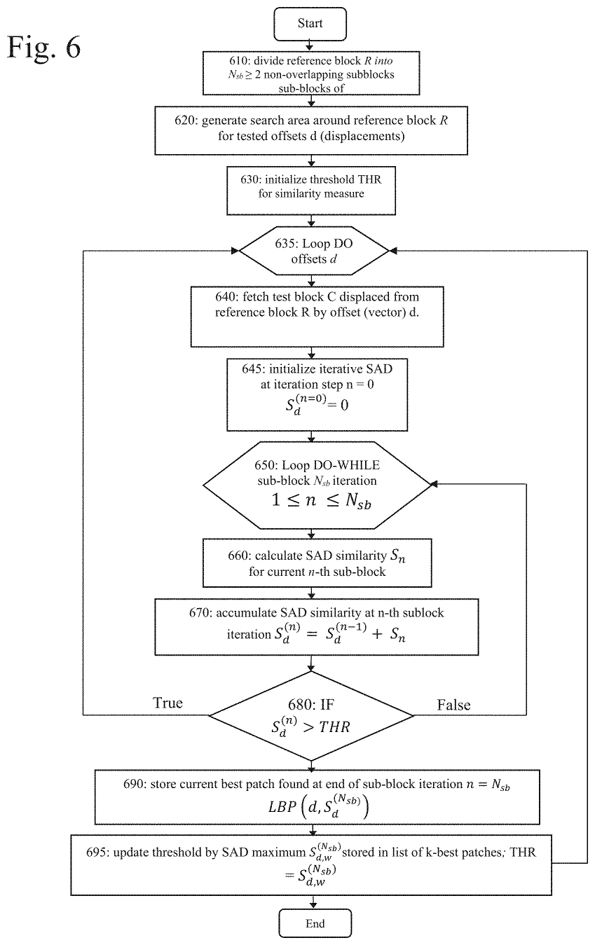

FIG. 6 shows the flowchart of the fast-search block-matching for finding K-best patches for one reference block within an image. It is noted that in the present disclosure, the terms “K” and “k” are used interchangeably to denote K best patches. The first step 610 consists in generating a number N_{sb} of two or more non-overlapping subblocks for the reference block R, with each subblock having a predetermined form and size. The form may be any of a sample row, sample column, sample square area, or sample rectangular area. In addition, these basic forms of the subblock can be taken in any combination thereof to implement a set of non-overlapping subblocks partitioning reference block R.

Then, in step 620, a search area around reference block R is generated, defining the search area for all possible offsets d within the image, corresponding to the possible positions of the K best patches to be found via block-matching.

Next, in step 630, a predetermined threshold THR is initialized, based on quantization step applied to quantize the image or on quantization noise of the image, based on comparing original and reconstructed frame. The quantization noise can also be derived from the quantization parameter QP, transferred from the encoder to the decoder side in lossy video codec, for example. The selection of the predetermined threshold is optimized further, based on a predefined cost function, as specified by rate, distortion, and the number of required operations (not shown in the flow chart). This threshold is used throughout the procedure to classify test block C in terms of low or high similarity in regards to reference block R, as described in the following.

Next, all possible offsets d within the search area are run through (Loop DO offsets d 635) and tested for best-match. This is performed for a test block C, which is located in a position shifted 640 with respect to reference block R by the current offset d, i.e., pos(C)=pos(R)+d, with pos returning position of the argument. The test block C is divided into the same subblocks as R. At the start of the iteration (n=0), the iteratively calculated similarity S_{d}⁽ⁿ⁾ is initialized 645; in the example of FIGS. 5 and 6, the SAD-based similarity is initialized S_{d}⁽ⁿ⁼⁰⁾=0. In the embodiment of FIG. 6, the similarity measure is based on SAD (sum of absolute differences), but other alternative metrics are possible, including e.g. sum of squared differences, correlation, or the like, as mentioned before.

For the selected offset d, the similarity S_{d}⁽ⁿ⁾ is then iteratively determined on a subblock basis with 1≤n≤N_{sb} (loop 650) by calculating 660 the similarity Sₙ for the current n^{th} subblock and adding Sₙ to S_{d}⁽ⁿ⁻¹⁾. Importantly, the similarity calculation on a subblock basis means that Sₙ is calculated only within the area corresponding to the n^{th} subblock. At the n^{th} step of the iteration, the accumulated 670 similarity is therefore given by S_{d}⁽ⁿ⁾=S_{d}⁽ⁿ⁻¹⁾+Sₙ and consists of the similarity Sₙ of the current n^{th} subblock and the similarity S_{d}⁽ⁿ⁻¹⁾ accumulated in the previous n−1 iteration steps.

At each step n of the iteration with 1≤n≤N_{sb}, the similarity S_{d}⁽ⁿ⁾ is compared 680 to the threshold THR to indicate low (TRUE) or high similarity (FALSE).

If S_{d}⁽ⁿ⁾ indicates a similarity lower than a predetermined similarity based on threshold (e.g., low similarity), the subblock-iteration for the particular offset d is terminated, i.e., the similarity Sₙ is not calculated further for the remaining N_{sb}−n subblocks and the current offset d is dismissed. The d-offset loop continues with the next possible offset value d in step 635. In the embodiment of FIG. 6, the low similarity is characterized, based on SAD, when S_{d}⁽ⁿ⁾>THR. Therefore, the block-matching of the embodiments of the present disclosure accelerates the search for k-best blocks (e.g., patches) by calculating similarity on a subblock basis, i.e., only within the area of a subblock in conjunction with a threshold-based stopping criteria, instead of calculating the similarity over the entire pixel range of the search area. In this way, unnecessary similarity calculations are avoided, so that the fast-search block-matching of the embodiments of the present disclosure provides a speed up by a factor 1.5 to 2 as benchmark tests show.

If S_{d}⁽ⁿ⁾ indicates a similarity higher than a predetermined threshold (high similarity), the block-iteration continues with the next subblock (Loop DO-WHILE subblock N_{sb} iteration 650). In the embodiment of FIG. 6, the high similarity is characterized, based on SAD, when S_{d}⁽ⁿ⁾<THR. If the similarity Sₛ⁽ⁿ⁾ continues to indicate high similarity for all subblocks 1≤n≤N_{sb}, such that S_{d}^{(N}^{_{sb}}⁾ indicates high similarity at the end of the subblock iteration (n=N_{sb}), one of k-best patches with similarity to reference block R is found.

The current best patch is put 690 to the list of k-best patches stored in a storage (e.g., a buffer with pre-defined size), including the current position (e.g., current offset d) of the matched block and the value of the current similarity measure S_{d}^{(N}^{_{sb}}⁾. The process of storing the current best patch into the storage includes, if the current buffer size is larger than the pre-determined buffer size of the storage, replacement of the offset value d (e.g., position) and the similarity measure in the storage indicating worst similarity (referred to as S_{d,w}^{(N}^{_{sb}}⁾) within the current list of k-best patches, by the calculated current similarity measure S_{d}^{(N}^{_{sb}}⁾ and the current offset d, if the current similarity (indicated by S_{d}^{(N}^{_{sb}}⁾) is higher than the similarity indicated by S_{d,w}^{(N}^{_{sb}}⁾. In the embodiment of FIG. 6, the worst similarity indicated by S_{d,w}^{(N}^{_{sb}}⁾ is determined, based on SAD, by the maximum SAD-value within the list of k-best patches.

The current threshold THR is then updated 695 by setting THR to the similarity measure S_{d,w}^{(N}^{_{sb}}⁾ from the list of k-best patches, indicating worst similarity with reference block R.

Finally, the next offset d is taken out from the set of offsets (e.g., positions) within the search area 635, and the above sequence is repeated till all possible offsets d are tested for best matching.

At the end of the procedure, K-best patches are stored for the current reference block R.

The described procedure of K best block-matching for one reference block R is repeated for all reference blocks R within the image, and are executed, for example, by a processing circuitry. The (reconstructed) frame, divided into a set of (reconstructed) image reference blocks, is now represented by the set of k-best image patches, each with spatial similarity to their particular reference block.

In the embodiment of FIG. 6, the search for k-best patches for one reference block has been exemplified using all possible offsets d within the search area around reference block R. The complexity of the block-matching, which is already lowered by performing the search on a subblock basis, can be further optimized by reducing the number of all possible offsets d via pre-selection, corresponding to the reduction of the search area around reference block R.

The present disclosure may be implemented in an apparatus. Such apparatus may be a combination of a software and hardware or may be implemented only in hardware or only in software to be run on a computer or any kind of processing circuitry. For example, the subblock iterative block-matching may be implemented as a primary stage to a filter unit performing collaborative filtering, for example, or, alternatively may be integrated into it, after the reconstruction processing of a video block for further processing of still image or video image coding and decoding. Such kind of processing may be performed by any processing circuitry such as one or more a chip (e.g., integrated circuit), which may be a general purpose processor, or a digital signal processor (DSP), or a field programmable gate array (FPGA), or the like. However, the present disclosure is not limited to implementation on a programmable hardware. It may be implemented on an application-specific integrated circuit (ASIC) or by a combination of the above mentioned hardware components.

Summarizing, the present disclosure relates to the iterative fast-search of K-integer best blocks (patches) by early termination of the iteration through a similarity threshold. In particular, the positions of K-best matched-blocks, divided into multiple subblocks, are found for a reference block within an image search area, by performing subblock-based iterative calculations of the similarity between a block at a current position and the reference block. The iteration progresses as long as the similarity remains larger than a threshold with the K-best patches being recorded, whereas the subblock iteration terminates when the similarity is lower than a threshold.

What is claimed is:

1. An apparatus for filtering a reference block based on K best-matching blocks within a search area of an image, K being an integer larger than one, the apparatus comprising a processing circuitry configured to:
divide the reference block into multiple non-overlapping subblocks,
calculate a similarity measure between the reference block and a block at a current position within the search area iteratively on a subblock basis, wherein the calculation is aborted, if the similarity measure in a current iteration indicates a similarity measure value lower than a predetermined threshold value,
include the current position among the positions of K best-matching blocks stored in a storage medium if the similarity measure calculated for all subblocks of the reference block indicates a similarity higher than the predetermined threshold value, and
filter the reference block using the K best-matching blocks located in the respective positions.

2. The apparatus according to claim 1, wherein the processing circuitry is configured to update the predetermined threshold value by setting the predetermined threshold value to a value corresponding to a function of the similarity measure value calculated between the reference block and a worst-matching block among the K best-matching blocks.

3. The apparatus according to claim 2, wherein the processing circuitry is configured to:
include the current position among the positions of K best-matching blocks stored in a storage medium by:
adding the current position among a plurality of stored positions of the K best-matching blocks if there are currently less than K positions of best-matching blocks stored in the plurality of stored positions;
replacing the position of the worst-matching block among the plurality of stored positions of the K best-matching blocks if there are currently K positions of best-matching blocks stored in the plurality of stored positions; and
updating the predetermined threshold value upon replacing the position of the worst-matching block among the plurality of stored positions of the K best-matching blocks.

4. The apparatus according to claim 1, wherein the processing circuitry is configured to perform the calculation in a loop for each position within the search area corresponding to the reference block.

5. The apparatus according to claim 4, wherein the processing circuitry is configured to set the predetermined threshold value to an initial value before starting the loop based on quantization noise of the image.

6. The apparatus according to claim 4, wherein the processing circuitry is configured to pre-select positions belonging to the search area based on properties of the image inside search area.

7. The apparatus according to claim 1, wherein:
the reference block and the search area are located within the same image; and
the processing circuitry is configured to determine a location of the search area within the image depending on a location of the reference block within the image.

8. The apparatus according to claim 1, wherein the similarity measure is a sum of absolute differences (SAD) or a sum of square differences (SSD).

9. The apparatus according to claim 1, wherein each of the multiple subblocks includes at least one image sample, and wherein a subblock has a form of any of: a sample row, a sample column, a square area of adjacent samples, or a rectangular area of samples.

10. The apparatus according to claim 1, wherein the storage medium is configured to stores, for the reference block, positions of the K best-matching blocks within the search area in association with the values of the similarity measure calculated between the K best-matching blocks and the reference block.

11. The apparatus according to claim 1, further comprising:
a filter configured to perform collaborative filtering of the reference block using the K best-matching blocks as patches.

12. An apparatus for encoding an image, the apparatus comprising:
an image coding circuitry configured to perform image compression and generating a bitstream including the coded image;
an image reconstruction circuitry configured to perform image reconstruction of the compressed image; and
the apparatus according to claim 11.

13. The apparatus according to claim 12, the apparatus further comprising:
an optimization circuitry configured to perform a rate-complexity-distortion process based on a predefined cost function, wherein the predefined cost function is based on a rate, a distortion, and a number of operations required, resulting in selection of:
the predetermined threshold value; and/or
a size and/or a form of the subblocks for the reference block.

14. An apparatus for decoding an image from a bitstream, the apparatus comprising:
a bitstream parser for extracting from the bitstream portions corresponding to a compressed image to be decoded;
an image reconstruction circuitry configured to perform image reconstruction of the compressed image; and
the apparatus according to claim 11.

15. The apparatus according to claim 14, wherein the image is a video image and the apparatus for image processing is a post filter.

16. The apparatus according to claim 14, wherein the image is a video image and the apparatus for image processing is an in-loop filter.

17. The apparatus according to claim 14, wherein the bitstream includes one or more of:
an indication of quantization noise,
an indication of event that quantization noise is derived from quantization parameter QP,
an indication of the predetermined threshold, and
an indication of a size and/or a form of the subblocks.

18. A method for filtering a reference block based on K best-matching blocks within a search area of an image, K being an integer larger than one, the method comprising the steps of:
dividing the reference block into multiple non-overlapping subblocks,
calculating a similarity measure between the reference block and a block at a current position within the search area iteratively on a subblock basis,
terminating the calculation if the similarity measure in a current iteration indicates a similarity measure value lower than a predetermined threshold value,
including a current position among positions of the K best-matching blocks if the similarity measure calculated for all subblocks of the reference block indicates a similarity measure value higher than the predetermined threshold value, and
filtering the reference block using the K best-matching blocks located in the respective positions.

19. A method for encoding an image comprising the steps of:
performing image compression and generating a bitstream including the coded image;
performing image reconstruction of the coded image; and
processing the reconstructed image according to the steps of claim 18.

20. A method for decoding an image from a bitstream comprising the steps of:
extracting from the bitstream portions corresponding to a coded image to be decoded;
performing image reconstruction of the coded image; and
processing the reconstructed image according to the steps of claim 18.

21. A computer-readable medium storing a program including instructions which, when executed on a processor performs the steps of:
dividing the reference block into multiple non-overlapping subblocks,
calculating a similarity measure between the reference block and a block at a current position within the search area iteratively on a subblock basis,
terminating the calculation if the similarity measure in a current iteration indicates a similarity measure value lower than a predetermined threshold value,
including a current position among positions of the K best-matching blocks if the similarity measure calculated for all subblocks of the reference block indicates a similarity measure value higher than the predetermined threshold value, and
filtering the reference block using the K best-matching blocks located in the respective positions.
